(19) United States
(12) Patent Application Publication
(10) Pub. No.: US 2011/0296191 A1
(43) Pub. Date: Dec. 1, 2011

(54) METHOD FOR SECURELY DRAWING UP A VIRTUAL MULTIPARTY CONTRACT CAPABLE OF BEING PHYSICALLY REPRESENTED

(75) Inventor: Stéphane Mouille, Gemenos (FR)

(73) Assignee: GEMALTO SA, Meudon (FR)

(21) Appl. No.: 13/147,447

(22) PCT Filed: Feb. 24, 2010
(86) PCT No.: PCT/EP2010/052360

§ 371 Date: Aug. 2, 2011

(30) Foreign Application Priority Data
Mar. 3, 2009 (EP) 09305196.9

(51) Int. Cl. H04L 9/32

(52) U.S. Cl. 713/176

(57) ABSTRACT

The invention relates to a method for securely drawing up a multiparty contract using digital certificates and electronic devices. Said method includes at least three steps: signing, countersigning, and formatting. The formatted document has the specific feature of being capable of being physically represented.

The invention relates to a method for securely drawing up a virtual multiparty contract capable of being physically represented.

The invention relates specifically to the field of electronically signing documents.

The general increase in the number of transactions, commercial or otherwise, has come hand in hand with a considerable rise in the number of contracts. The term contract is understood herein to refer to “a document ratifying the acceptance by at least two co-signatories of a predefined subject matter”. Examples of contracts in everyday life include, for example, the sales contracts that commit a seller and a purchaser regarding an object being sold, or the cheques that commit the purchaser and the seller to a payment.

Contracts can be binding on more than two co-signatories. For example, in the context of a consumer credit contract, the co-signatories are the purchaser, the seller and the bank.

Said contracts can come in two different forms: a physical form and a virtual form.

Physical contracts are traditionally drawn up on a physical medium, signed and countersigned generally by hand, producing a number of copies at least equal to the number of co-signatories. Each one of the co-signatories keeps a copy of said contract. The main advantages of this type of contract are:
the human readability thereof. Indeed, any person who is capable of reading the language of the contract is able to obtain the subject matter thereof as well as the identity of the signatories. The signatures affixed on said contract can also be studied.
the maturity of the processing means. Indeed, a very large number of means currently exist for processing said contracts. Said means generally require more or less automated input.

Said contracts, however, have one major flaw, which is the value of the signature thereof. Indeed, handwriting is not easily “verified” and the identities of the signatories generally depend on visual inspection of an identity document, carried out by a physical person. The great diversity of identity documents makes this inspection very difficult and risky. Indeed, each country produces a large number of official identity documents, such as driving licenses, ID card, passports and son on. Moreover, greater free circulation of people within certain geographical areas of the planet (Europe etc.) brings a larger variety of official documents.

Since a large number of government bodies now recognise electronic signatures, the number of so-called virtual contracts is constantly on the rise.

Said contracts are generally in digital format with electronic signatures affixed thereon.

Electronic—or digital—signatures are suitable, for example, for guaranteeing the authenticity and integrity of data, as well as the identity of the signatory. If confidentiality is required, the contents of the message must be encrypted.

In general terms, encryption consists of rendering the text of a message unreadable for any person who does not hold the decryption key. In symmetrical encryption systems, a single key can be used both to encrypt and to decrypt the data. Said key must be kept secret by the interested parties in order to guarantee the security of the information. The main drawback lies in the fact that the originator and the receiving party must agree on the key in advance and must have a secure channel for exchanging said key.

This is why the electronic signature systems developed in recent years are based on asymmetric encryption algorithms in which, in addition, each user has two keys: a public key and a private key. Said two keys are in turn created using mathematical algorithms. Said keys are uniquely linked to one another and are specific to a given user. A message encrypted using an asymmetric algorithm and a private key, which constitutes one of the parameters of the algorithm, can only be decrypted using the relevant public key, and vice-versa. The public key must therefore be known to all parties, while the private key remains secret, with smart cards appearing to be the best medium for storing private keys. When the asymmetric encryption algorithm is only used to create the electronic signature, the same private and public keys are used, but only to verify the authenticity and integrity of the message.

Said electronic signatures, obtained by the application of asymmetric algorithms, are sometimes called digital, in contrast with the electronic signatures created by means of other devices.

According to the United Nations Commission on International Trade Law, a digital signature is “a numerical value, which is affixed to a data message and which, using a known mathematical procedure associated with the originator's private cryptographic key, makes it possible to determine uniquely that this numerical value has been obtained with the originator's private cryptographic key. The mathematical procedures used for generating authorised digital signatures are based on public-key encryption. When applied to a data message, those mathematical procedures operate a transformation of the message such that a person having the initial message and the originator's public cryptographic key can accurately determine: a) whether the transformation was operated using the private cryptographic key that corresponds to the originator's public cryptographic key; and b) whether the initial message was altered after the transformation was made ( . . . )”.

Unlike handwritten signatures, digital signatures, which are made up of numbers, letters and other symbols, do not include any elements that allow the signature to be attributed to a specific person. Each user must therefore ascertain the identity of his or her correspondents. This is the reason why certification services are used, often referred to as “trusted third parties” or “certification authorities”, which receive the trust of each party and guarantee that a signature belongs to a specific person. Since the receiving party uses the originator's public key to verify the latter's electronic signature, verification implies the third party certifying before the receiving party that the public key used actually matches the private key of the original signatory and that said signatory is actually the person he or she claims to be. The certification authority thus issues authentication certificates that include, on the one hand, diverse information about the person whose identity is sought to be verified (name, surname, date of birth, etc.) and, on the other hand, the public key of said person. Said certificates are generally collected in databases stored on-line on the internet, ensuring easy access by each person.

The digital signature therefore constitutes a block of data created using a private key; the corresponding public key and the certificate being suitable for verifying that the signature was actually generated using the associated private key, that the signature actually belongs to the originator and that the message is unaltered.

Today, said solutions are still highly compartmentalised. The present invention proposes producing a contract that offers the guarantees of a virtual contract while retaining the readability and the processing means of a physical contract.

For this purpose, the invention initially relates to a method for securely drawing up a digital contract between at least a first electronic communication device, a second electronic communication device and a trusted third party, the first and second communication devices each having at least one private key/public key pair, and a certificate of authenticity with regard to an asymmetric algorithm ASYM, the trusted third party holding all or part of the public information of the electronic communication devices.

Said method includes at least the following steps of:
signing, in which the first electronic communication device signs, by means of the private key thereof and the asymmetric algorithm ASYM, all or part of a digital document, and adds said signature to the digital document in an optically readable format, such as to produce a signed document;
countersigning, in which the second electronic communication device signs, by means of the private key thereof and the asymmetric algorithm ASYM, all or part of the signed document, and adds said signature to the signed document in an optically readable format, such as to produce a countersigned document;
editing, formatting the countersigned document in a printable format that ensures optical readability of the contents of the document and of the two electronic signatures, independently from one another.

In one embodiment of the invention, during the signing step, the first electronic communication device calculates a security value and adds said value to the electronic document prior to signing the document.

In another embodiment of the invention, during the countersigning step, the second electronic communication device calculates a security value and adds said value to the signed document prior to signing the document.

Said security values can be, for example, random numbers, or a function of the date.

According to one embodiment of the invention, prior to signing the digital document, the first electronic communication device transmits all or part of the public components of the identity thereof to the trusted third party, which verifies said identity and returns information that is used to calculate the security value.

In another embodiment of the invention, prior to countersigning the signed document, the second electronic communication device transmits all or part of the public components of the identity thereof to the trusted third party, which verifies said identity and returns information that is used to calculate the security value.

During the signing step, the first electronic communication device can modify the electronic document. Said modification can, for example, consist of inserting information contained in the first electronic device in the electronic document or deleting one or more pieces of original information from the electronic document, according to information contained in the first electronic device.

During the countersigning step, the second electronic communication device can modify the signed document. Said modification can, for example, consist of inserting information contained in the second electronic device in the signed document or deleting one or more pieces of original information from the signed document, according to information contained in the second electronic device.

On the document in printable format, the electronic signatures can be, for example, written in digital form, or in barcode form.

The invention also relates to a method for processing a digital contract between at least one signatory, one countersignatory and a trusted third party, the signatories and countersignatories each having at least one private key/public key pair and a certificate of authenticity relative to an asymmetric algorithm ASYM, the trusted third party holding all or part of the public information of the signatories and countersignatories, and an electronic device, referred to as the receiver.

Said method includes at least the following steps of:
reception, during which the receiver obtains a signed and countersigned digital document,
signatory authentication, during which the receiver reads the countersignature on the document, contacts the trusted third party in order to obtain the countersignatory's public key and verifies the correlation between the countersignature and the public key using the asymmetric algorithm ASYM,
countersignatory authentication, during which the receiver reads the signature on the document, contacts the trusted third party in order to obtain the signatory's public key and verifies the correlation between the countersignature and the public key using the asymmetric algorithm ASYM,
processing, during which the contents of the digital document are analysed.

Additional features and advantages of the invention will clearly emerge from the following description thereof, provided in a non-exhaustive manner for information purposes only, in reference to the appended drawings, in which:

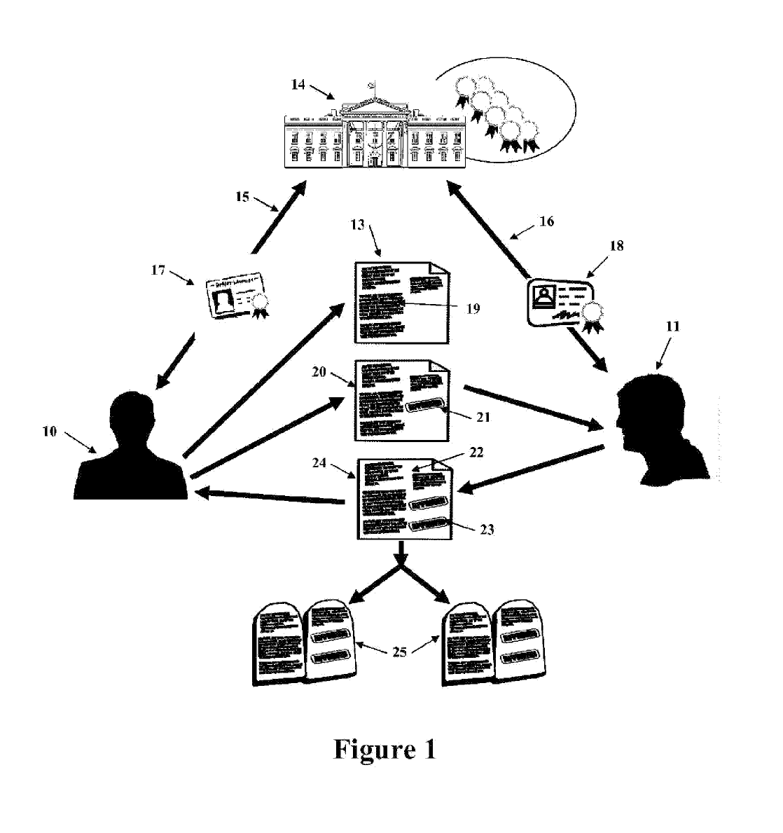

FIG. 1 shows the drawing up of a contract between two players,

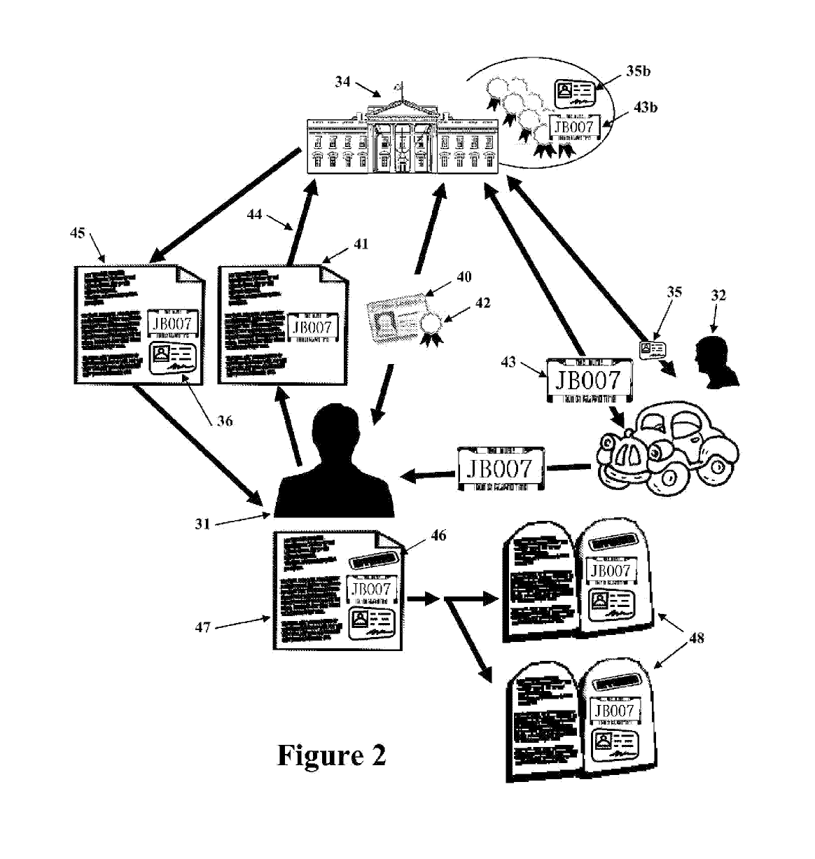

FIG. 2 shows the drawing up of a contract in absentia between three entities.

The present invention is especially suited to a multi-user context with a central entity acting as a trusted third party. A government, for example, can play this role of a trusted third party, rolling out a public-key cryptography system (referred to as PKI) via the electronic identity cards said government issues.

A broader supra-governmental scheme is possible when an independent body performs this role of trusted third party (for example the ICAO, European Commission, Regional Federation of States, etc.).

FIG. 1 shows the drawing up of a tripartite contract according to the invention. Indeed, said embodiment takes place in a context in which two users 10 and 11 draw up a contract 13, duly signed, with the assistance of a trusted third party 14, represented in this case by a government body. Said central entity is responsible for managing the keys and certificates required for applying public-key protocols. The users 10 and 11 are bound to the government entity by respective contracts 15 and 16. Said contracts are not included in the present invention, and will therefore not be described herein, but they guarantee the information supplied by the trusted third party. In a national embodiment of the invention with a government body acting as a trusted third party, said contracts 15 and 16 represent, for example, the nationality of the users 10 and 11. Indeed, by virtue of the nationality of the users, a link exists with the government which, by providing said users with an identity document, guarantees the identity of said users as national residents.

The solution described in FIG. 1 depicts the least secure case in which the two cosignatories of a contract are physical persons each holding electronic identity documents 17 and 18. Each one of said electronic documents contains at least one microprocessor, a working memory and input/output interfaces. Said documents, for example such as contactless electronic national identity cards supplied by the government body 14, can also be, for example a driving license, a full residence permit, a residence card, a health card or even a passport. Any document issued and approved by the government body 14 can be used. One constraint is that said documents must have electronic functionalities that enable said documents to store and use cryptographic functionalities.

If a document, for example any of the documents mentioned above, does not have said functionalities, the latter can be provided by combining the document with, for example, an electronic complement such as an electronic tag with the document. In this case, the resulting document, made up of the passive document and the electronic add-on, will make up the documents 17 or 18.

A specific case can be seen with visas. A visa is a document issued by the proper authorities of a country, which a foreign national must present when entering the territory of a state of which said person is not a national. In order to be valid, a visa generally must be attached to a passport.

In the event that the visa provides the electronic functionalities required to implement the invention, documents 17 and 18 can consist of a passport combined with an electronic visa.

When drawing up a contract 13, the user 10 produces the digital body 19 of the contract. Said contract body represents all or part of the subject matter of the contract. Said subject matter can be represented by text, but the digital portion of the contract in this step allows any other form of document to be accepted, for example video or audio.

In a preferred embodiment of the invention, the user 10 completes said digital body 19 with data from the user's own electronic identity document 17. Said data can be, for example, a set of identification data, or even banking or tax information recorded upstream in the electronic document 17.

In the case that the document 14 is, for example, a sales contract, the seller 10 provides the description 19 of the object being sold, also inserting the identity of the user and the details of the bank account to which the payment must be made in the body 19.

In this step, it is possible for the purchaser 11 also to add information, for example relating to the purchaser's identity and bank details.

In the event that the body 19 is not textual, the object being sold can be illustrated through a video, and the additional information can be provided, for example, in an audio file.

The seller 10 will then digitally affix his or her signature 21 on the document 19 such as to produce a signed contract 20. The signature is produced in accordance with asymmetric cryptography algorithms ASYM of the prior art, such as RSA (acronym standing for Rivest Shamir Adleman), or else elliptic-curve algorithms.

This step is generally carried out by sending the document 19 to the electronic document 17. The cryptographic calculations are generally performed inside the electronic document in order to minimise the circulation of secret information, in particular the secret key.

Said signature can, for example, be generated by producing a digest of the body 19 of the contract using a hashing function, and by encrypting said hash with the private key of the seller 10 and an asymmetric algorithm, for example RSA. The product of said encryption can form the signature 21 of the document 19 by the seller 10.

In the embodiment depicted in FIG. 1, the signed document 20 contains the body of the contract 19 in a freely readable form, as well as the signature 21.

Another embodiment is foreseeable in which the signing operation does not retain the body 19 in a freely readable form, but rather encrypts said body in order to guarantee the confidentiality thereof.

The seller 11 can then, as required, add information to the body 19 and thus produce a new body 22. The added information includes, in the current example, the identity of the user, the price of the transaction and the purchaser's bank details.

The purchaser will then countersign the document. In the event that the purchaser 11 has created a document 21 by adding information, this is the document which will be digitally signed. If no information has been added, the body 19 that was also signed by the seller 10 will be signed.

The signature 23 of the purchaser 11 is calculated in a similar fashion to how the signature 21 of the seller 10 is produced.

The signature 23 thus produced is added to the document in order to produce a countersigned document 24.

Said document must be formatted in order to be produced in a physically representable format 25. The most common method for physical representation consists of printing.

A physically representable format is a physical format, which is no longer digital, and which cannot be duplicated.

Said property of “duplicability” is a strong element in differentiating physical objects from virtual objects. Indeed, a virtual—or digital—object can be infinitely duplicated without altering the quality of the copy or the original. This is the case, for example, with a computer file, which can be sent, identically, to a plurality of receiving parties without thereby altering the original file.

On the other hand, a physical object can also be sent, but at that time the original owner no longer possesses the object. In the case of an information medium, it is always possible to make copies (for example, photocopies, or copies of audio cassettes), but these are not identical copies, and repeated copying results in noticeable alteration of the quality of the copies.

The only copies that do not alter the quality of the copy or the medium are copies without reproduction, which actually involve creating a new object that is similar to the first object. This case cannot therefore be taken into account, since it involves two physical objects each with its own “life”, each with a separate author, creation date, etc., but with similarities. In-depth analysis of such a copy would be guaranteed to detect differences (for example the chemical composition of components of the ink or medium, the nature of the impurities found in the medium, etc.).

The document format 25 has the additional specific feature of containing the signatures 21 and 23 in an optically readable format. Said signatures can be read by the human eye or by any other optical capture means. In a specific embodiment of the invention, the signatures can consist of a string of numbers or a barcode.

The document thus produced can then follow either one of two possible channels: either automated processing, in which case the document remains in virtual, digital form; or else physical representation in order to undergo conventional processing.

Said physical representation can advantageously be performed by printing. In a preferred embodiment of the invention, in the printed document, the body 14 is retained in readable form. If the contents of the body do not consist of text but rather other types of information, said documents can be converted to digital format and then transcribed as raw data. Thus, a video file can be transcribed as a string of printable characters, for example in MIME format (acronym standing for Multipurpose Internet Mail Extensions), which converts any type of document attached to an e-mail into a string of printable characters in order to transmit said documents under optimum conditions.

FIG. 2 shows one embodiment of the invention in which a contract 30 is drawn up between three players 31, 32 and 33, each under contract with the trusted third party 34, in this case represented by a government entity.

Said embodiment presents the case in which a police officer 31 issues a road user 32 with a fine because the latter's vehicle 33 is parked in a no-parking area.

The police officer 31 is in possession of an electronic document 40 which contains personal, professional and cryptographic information, and was issued by the government entity 34. Said electronic document can be, for example, a license provided with an electronic chip.

When noticing the offence, the officer 31 is standing next to the vehicle 33, but not necessarily next to the owner 32 thereof. The officer takes out his or her communication terminal 35 and begins to draw up a parking ticket 41.

In this embodiment, the officer presents his or her electronic card to the terminal, which initiates radio communication with the card, and in turn receives a certificate 42 with the identity of the officer. Then, the terminal establishes communication, over a mobile telephone network, with a server belonging to the government entity 34, and supplies the latter with the certificate. If the certificate matches that of an active officer, then the terminal receives the authorisation to continue with the proceedings.

The officer selects a fine form 41 on his or her terminal according to the offence detected, in this case unlawful parking.

The card 40 provides information relating to the officer which is necessary in order to draw up the fine. For example, the identity of the officer 31, his or her license number and his or her rank. The terminal in turn supplies other information such as, for example, the date and time.

Said information is used to fill in the body of the fine 41. In another embodiment of the invention, the fine form can contain information such as, for example, the exhaustive list of active officers. In this case, the officer's license can erase from the body of the fine the identifiers of all officers other than the officer 31 currently drawing up the fine. This is an important embodiment, since it makes it possible in certain specific contexts to share responsibility between the card, which removes certain information, and the supplier of the contents of the document, which provided the exhaustive list. Thus, if the card was experiencing erratic operation, it would not have filled in the document in a completely incoherent manner, since the role of the card would have been limited by the list of information provided.

The officer can then enter the registration plate of the car 33 committing the offence. In a more elaborate embodiment of the invention, the identity of the vehicle can be provided, for example, by an electronic device such as a contactless chip, which would make it possible directly to obtain a security certificate associated with the vehicle.

Once the registration plate 43 details have been entered in the terminal, the latter establishes contact with a remote government server 34. Said communication preferably takes place over a mobile telephone network. By providing the registration plate details, the server obtains the official registration details 43 of the vehicle in the country (carte grise in France), and thereby identifies the legitimate owner 35b of the vehicle. In one embodiment, the server supplies the data 36 required for drawing up the fine to the terminal, which fills in the document. Said data comprise, for example, technical specifications of the car (power etc.) as well as the identity of the owner, including marital status, contact details and, for instance, tax details.

At this point, the document 45 thus filled in is sent to the electronic card 40 of the officer 31, who creates a signature 46 for the document and affixes said signature thereto.

The document 47 is then transmitted to the government server 34, which in turn signs the document using the cryptographic data associated with the vehicle, and again with the data associated with the owner.

The document thus created is then printed 48 by the officer's terminal and affixed to the vehicle. At the same time, an electronic version is sent to the owner's e-mail address and another version is sent to the tax office to which the offender belongs.

The offender can then process the fine either electronically or by regular mail, as before.

The fine cannot be contested, since the identity of the officer was proven when the fine was drawn up and the identity of the vehicle and identity of the owner were confirmed.

If the offender is present, the fine can be drawn up in a much more straightforward manner, reducing the number of exchanges with the government server, or even off-line.

The present invention advantageously applies to at least partially electronic identity documents.

Completely electronic documents include, for example, dedicated electronic devices such as USB keys (acronym standing for Universal Serial Bus).

Partially electronic documents include, for example, electronic memories that contain secured information, and which need to be connected to an electronic device in order to be usable. For example, such documents can be in the form of memory cards, such as MMC (acronym standing for MultiMedia Card), SD (acronym standing for Secure Digital card) or CompactFlash cards. In these specific embodiments of the invention, the identity document in accordance with the present invention is made up of said electronic components plus any medium whatsoever. Thus, the successive use of such a component combined with various host devices is considered as the use of a single electronic document in accordance with the present invention.

The present invention also applies to dematerialised identity documents. Said dematerialised identity documents can, for example, be in the form of a software application on board a host electronic device providing the required communication and processing functionalities.

Thus, for example, an “identity card” application on board a mobile phone forms an identity document according to the invention.

1. A method for securely drawing up a digital contract between at least a first electronic communication device, a second electronic communication device and a trusted third party, said first and second electronic communication devices each having at least one public key/private key pair and a certificate of authenticity with regard to an asymmetric algorithm ASYM, said trusted third party holding all or part of the public information of said electronic communication devices,
wherein said method includes at least the steps of:
signing, in which said first electronic communication device signs, by means of the private key thereof and said asymmetric algorithm ASYM, all or part of a digital document, and adds said signature to said digital document in an optically readable format, such as to produce a signed document;
countersigning, in which said second electronic communication device signs, by means of the private key thereof and said asymmetric algorithm ASYM, all or part of said signed document, and adds said signature to said signed document in an optically readable format, to produce a countersigned document;
editing, in which said countersigned document is formatted in a printable format that ensures optical readability of the contents of said document and of said two electronic signatures, independently from one another.

2. A method according to claim 1, wherein, during the signing step, said first electronic communication device calculates a security value and adds said value to said electronic document prior to signing the document.

3. A method according to claim 1, wherein, during the countersigning step, said second electronic communication device calculates a security value and adds said value to said signed document prior to signing the document.

4. A method according to claim 2, wherein said security value is a random number.

5. A method according to claim 2, wherein said security value is a function of the date.

6. A method according to claim 2, wherein, prior to signing said digital document, said first electronic communication device transmits all or part of the public components of the identity thereof to said trusted third party, which verifies said identity and returns information that is used to calculate said security value.

7. A method according to claim 3, wherein, prior to countersigning said signed document, the second electronic communication device transmits all or part of the public components of the identity thereof to said trusted third party, which verifies said identity and returns information that is used to calculate said security value.

8. A method according to claim 1, wherein, during the signing step, said first electronic communication device modifies said electronic document.

9. A method according to claim 8, wherein said modification comprises inserting information contained in said first electronic device in said electronic document.

10. A method according to claim 8, wherein said modification comprises deleting one or more pieces of original information from said electronic document, according to information contained in said first electronic device.

11. A method according to claim 1, wherein, during the countersigning step, said second electronic communication device modifies said signed document.

12. A method according to claim 8, wherein said modification comprises inserting information contained in said second electronic device in said signed document.

13. A method according to claim 8, wherein said modification comprises deleting one or more pieces of original information from said signed document, according to information contained in said second electronic device

15. A method according to claim 1, wherein, on said document in printable format, said electronic signatures are written in barcode form.

16. A method for processing a digital contract between at least one signatory, one countersignatory and a trusted third party, said signatories and countersignatories each having at least one private key/public key pair and a certificate of authenticity relative to an asymmetric algorithm ASYM, said trusted third party holding all or part of the public information of said signatories and countersignatories, and an electronic device, referred to as the receiver,
wherein said method includes at least the steps of:
reception, during which said receiver obtains a signed and countersigned digital document,
signatory authentication, during which said receiver reads the countersignature on said document, contacts said trusted third party in order to obtain the countersignatory's public key and verifies the correlation between said countersignature and said public key using said asymmetric algorithm ASYM,
countersignatory authentication, during which said receiver reads the signature on said document, contacts said trusted third party in order to obtain the signatory's public key and verifies the correlation between said countersignature and said public key using said asymmetric algorithm ASYM,
processing, during which the contents of said digital document are analysed.
